(19) United States
(12) Patent Application Publication
(10) Pub. No.: US 2021/0380055 A1
(43) Pub. Date: Dec. 9, 2021

(54) VEHICULAR INDEPENDENT SOUND FIELD FORMING DEVICE AND VEHICULAR INDEPENDENT SOUND FIELD FORMING METHOD

(71) Applicant: SQAND CO. LTD, Yuseong-gu Daejeon (KR)

(72) Inventors: Yang-Hann KIM, Yuseong-gu Daejeon (KR); Jong-Hwa LEE, Yuseong-gu Daejeon (KR); Joon-Young PARK, Yongin-si Gyeonggi-do (KR); Wan-jung KIM, Jung-gu Daejeon (KR); Hwan KIM, Yuseong-gu, Daejeon (KR)

(21) Appl. No.: 17/286,077

(22) PCT Filed: Oct. 17, 2019
(86) PCT No.: PCT/KR2019/013620

§ 371 Date: Apr. 16, 2021

(30) Foreign Application Priority Data
Oct. 17, 2018 (KR) 10-2018-0123934

(51) Int. Cl. B60R 16/037; B60R 16/023; H04W 4/48

(52) U.S. Cl. CPC B60R 16/037; B60Y 2400/3044; H04W 4/48; B60R 16/023

(57) ABSTRACT

An in-car personalized sound field forming device which communicates with a device for providing a sound source according to an exemplary embodiment of the present invention includes: a storage unit configured to store a filter coefficient for converting the sound source so that a sound is concentrated in a predetermined focusing area in a vehicle; a communication unit configured to receive vehicle driving state information in the vehicle; and a control unit configured to update the filtering coefficient according to the vehicle driving state information received from the communication unit and control a volume adjustment range of the sound source so that the sound is reproduced in the focusing area.

### TECHNICAL FIELD

The present invention relates to an in-car personalized sound field forming device and an in-car personalized sound field forming method, and more particularly, to an in-car personalized sound field forming device and an in-car personalized sound field forming method, which control a volume gain of a sound source so as to allow a sound to be reproduced in a focusing area according to vehicle driving state information in order to improve the effectiveness in forming the personalized sound field.

### BACKGROUND ART

With the development of an Audio, Video, Navigation (AVN) system provided in a vehicle, interest in in-vehicle sound is increasing, such as outputting sounds from portable devices, such as a mobile terminal, a Portable Multimedia Player (PMP), and an MP3 player, through a speaker by using a wired/wireless connection means, such as Bluetooth or AUX. In particular, research is being actively conducted to adjust the sound output through the in-vehicle speaker according to a location (the passenger's seat position) within the vehicle.

The sound control uses a sound field reproduction method, an active noise control method that reduces the volume of sound in a space by using a plurality of active sound sources, a method of changing an interval between sound sources arranged in a specific shape, a method of changing the time delay and volume gain between sound sources to increase sound power output at a specific angle, and the like.

In particular, it is very important to implement a method in the vehicle, in which the sound source is heard louder in a specific area within the vehicle and the sound source is hardly heard in other areas. However, when other background noise, other than the sound source, is scattered in the vehicle, it is necessary to properly implement a personalized sound field even if there is background noise.

### DISCLOSURE

### Technical Problem

An object of the present invention is to improve the effectiveness of the personalized sound field forming method by reflecting the vehicle driving status in controlling the sound sources, so that so that a sound is not heard well in the non-focusing area by controlling a range of sound reproducible in a focusing area set so that a sound is relatively heard well.

### Technical Solution

According to an exemplary embodiment of the present invention, an in-car personalized sound field forming device which communicates with a device for providing a sound source may include: a storage unit configured to store filter coefficients which will be applied to the sound source signals so that the sound can be concentrated in the predetermined focusing area in a vehicle communication unit configured to receive vehicle driving status from the vehicle; and a control unit configured to update the filtering coefficient according to the vehicle driving state information received from the communication unit and control a volume adjustment range of the sound source so that the sound is reproduced in the focusing area.

According to another exemplary embodiment of the present invention, a method of forming a personalized sound field in an in-car personalized sound field forming device may include: receiving a sound source; reading a filter coefficient for converting the sound source so that a sound is concentrated in a predetermined focusing area in a vehicle; receiving vehicle driving state information in the vehicle; and updating the filter coefficient according to the vehicle driving state information and controlling a volume adjustment range of the sound source so that the sound is reproduced in the focusing area.

### Advantageous Effects

In the present invention, the effect of the personalized sound field implemented so that a sound is not heard well in the non-focusing area may be more accurately reflected by controlling a range of sound reproducible in a focusing area set so that a sound is relatively heard well by reflecting the vehicle driving status. In particular, an independent listening style of an individual user positioned on each seat may be further guaranteed.

It is possible to focus a sound in a vehicle to a specific area by using an existing speaker mounted in the vehicle or mounting only an additional speaker for improvement of performance.

It is possible to respect the listening style of each listener located in each seat according to a vehicle driving state, thereby controlling the personalized sound field.

Additionally, the sound may be controlled to be heard only in a specific location (bright zone) and controlled to be very weakly heard or not to be heard in other locations (dark zone), and a user may select or adjust the sound focusing in the vehicle.

The object of the present invention is to provide a personalized sound field forming device which is capable of focusing a sound inside a vehicle in a specific area by using an existing mounted speaker without changing a location of the speaker in the vehicle.

According to the exemplary embodiment of the present invention, it is only necessary to separately insert the in-car personalized sound field forming device into the existing system without replacing an in-car AVN device already installed in the vehicle, so that there is an advantage in that a personalized sound field forming system is more easily implemented.

### DESCRIPTION OF DRAWINGS

FIG. 1 is an in-car personalized sound field forming system for describing an in-car personalized sound field forming device according to an exemplary embodiment of the present invention.

FIG. 2 is a diagram illustrating an example in which the personalized sound field forming device is installed inside a vehicle.

FIG. 3 is a diagram illustrating a lookup table stored in a storage unit of the personalized sound field forming device according to an exemplary embodiment of the present invention.

FIG. 4 is a flowchart for describing an in-car personalized sound field forming method according to an exemplary embodiment of the present invention.

### BEST MODE

### Mode for Carrying Out the Invention

In the detailed description of the present invention described below, reference is made to the accompanying drawings, which illustrate a specific exemplary embodiment in which the present invention may be carried out, as an example. The exemplary embodiment is described in detail sufficient to enable a person skilled in the art to carry out the present invention. It should be understood that various exemplary embodiments of the present invention are different from each other, but need not to be mutually exclusive. For example, specific shapes, structures, and characteristics described herein may be implemented in other exemplary embodiments without departing from the spirit and the scope of the present invention in relation to one exemplary embodiment. Further, it should be understood that a location or disposition of an individual component in each disclosed exemplary embodiment may be changed without departing from the spirit and the scope of the present invention. Accordingly, the detailed description below is not intended to be taken in a limited meaning, and the scope of the present invention, if appropriately described, is limited only by the appended claims along with all scopes equivalent to those claimed by the claims. Like reference numerals in the drawings refer to the same or similar functions over several aspects.

According to a general personalized sound field forming system, different sounds may be heard by separating sounds between the seats in a vehicle. However, the system does not consider background noise generated in a vehicle separately from a sound source device providing a sound source, so that in reality, the effect of the personalized sound field is not properly exhibited.

For example, in the case where background noise in a vehicle is 50 DB and a difference in a sound pressure between the seats is 20 DB, a sound of 60 DB may be heard in an area in which a sound is relatively well heard, and a sound of 40 DB may be heard in an area in which a sound is relatively hard to be heard. However, in the area in which the sound is relatively hard to be heard, even though the sound of 40 DB is heard, the sound is buried in the background noise, and as a result, it is difficult to hear the sound, the personalized sound field may be implemented.

However, in the same case, when a sound of 80 DB is set to be heard in the area in which the sound is relatively well heard, and a sound of 60 DB is set to be heard in the area in which the sound is relatively hard to be heard, the sound of 60 DB exceeds the background noise of 50 DB even in the area in which the sound is relatively hard to be heard, and as a result, the sound is heard. In this case, the personalized sound field is not properly implemented.

Accordingly, in the present invention, the effect of the personalized sound field implemented so that a sound is not heard well in the non-focusing area may be more accurately reflected by controlling a range of sound reproducible in a focusing area set so that a sound is relatively heard well in consideration of even vehicle driving state information.

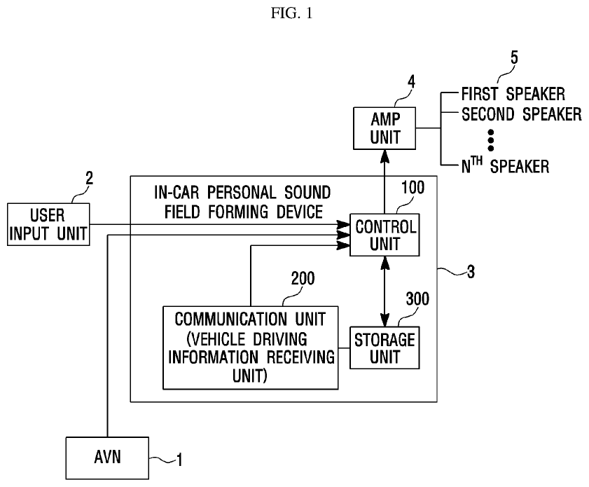

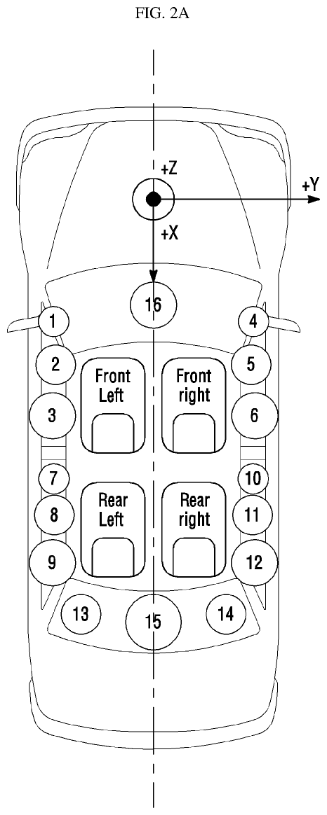

FIG. 1 is a block diagram illustrating an in-car personalized sound field forming system according to an exemplary embodiment of the present invention.

The in-car personalized sound field forming system according to the exemplary embodiment may include an Audio, Video, Navigation (AVN) device 1, a user input unit 2, an in-car personalized sound field forming device 3, an amp unit 4, and a speaker unit 5.

The AVN device 1 is an audio system basically installed in the vehicle, and is connected with internal/external devices through wired or wireless communication to supply various sound sources. As the method of the wired/wireless connection between each module and the internal/external device, various existing method may be used. Detailed descriptions thereof will be omitted.

The user input unit 2 receives a user input for a sound source signal supplied from the AVN device 1. Otherwise, depending on an exemplary embodiment, the user input unit 2 may also autonomously supply a sound source. The user input unit 2 may be implemented with a device, such as a touch screen (not illustrated), a jog shuttle (not illustrated), a switch (not illustrated), a button (not illustrated), and the like. The user input unit 2 may receive a user input for a location selection of a bright zone BZ in which an output of the sound source signal is to be focused. The user selection information through the user input unit 2 may be transmitted to the control unit 100 through wired or wireless communication (WIFI, BT, and the like).

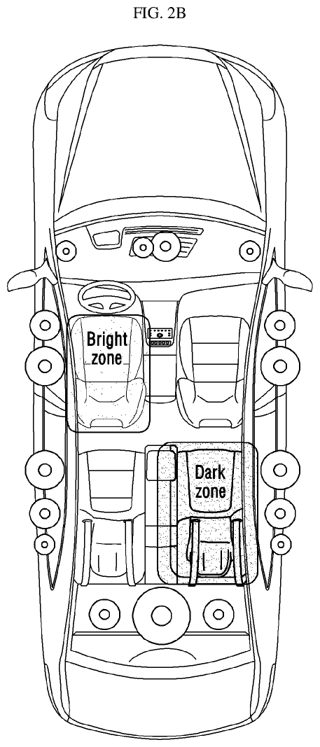

For example, when an image illustrated in FIG. 2B is displayed on a touch screen, a user may select a location that is to be set as the bright zone BZ while checking the corresponding image. The user input related to the setting of the location of the bright zone BZ is used for generating the sound signal by the control unit 100, and in particular, determines a filter coefficient for filter a sound source signal.

In order to provide an interface for convenience of a user's manipulation, the area to be set as the bright zone BZ in response to the user input through the jog shuttle (not illustrated), the switch (not illustrated), or the like may be visually displayed through a display in the vehicle.

Depending on an exemplary embodiment, the user input unit 2 may include a mobile terminal including a touch screen (a smart phone, a tablet PC, and the like). Even the area in which the corresponding sound source is to be focused may be selected by the user through a touch screen.

Depending on the exemplary embodiment, the user input unit 2 provides a sound source and the AVN device 1 also provides another sound source, so that the areas, in which the two types of sound sources are to be focused, respectively, may also be selected through the user input unit 2. However, in this case, the filter coefficient for each area may be independently applied. That is, a first filter coefficient is applied to a first focusing area, so that a first sound source may be output as a first sound signal, and a second filter coefficient is applied to a second focusing area, so that a second sound source may be output as a second sound signal. In this case, in particular, an independent listening style of an individual user positioned on each seat may be further guaranteed.

For example, there is a case where a mobile terminal needs to output a sound (for example, ringtone, call sound) while music is being played through the in-vehicle AVN device 1. In this case, it is necessary to control a location in which the output of the music is focused and a location in which an alarm sound of the mobile terminal is focused. For example, music needs to be heard in the passenger seat, and the call sound needs to be usually heard in the driver's seat. In this case, it is possible to control the locations of various sounds output in the vehicle by using the filter coefficient for each focusing area. Otherwise, according to another exemplary embodiment, the first sound source and the second sound source may also be provided together through the in-vehicle AVN device 1, and the areas, in which two types of sound sources are to be focused, respectively, may also be selected through the user input unit 2. Even in this case, the filter coefficient for each area may be independently applied.

Further, in particular, according to the exemplary embodiment of the present invention, it is only necessary to separately insert the in-car personalized sound field forming device 3 into the existing system as illustrated in FIG. 1 without replacing the in-car AVN device 1 that is already installed in the vehicle, so that there is an advantage in minimizing transformation of the existing system. However, this is merely an exemplary embodiment, and according to another exemplary embodiment, the in-car AVN device 1 and the personalized sound field forming device 3 may also be implemented in the form of one system.

The in-car personalized sound field forming device 3 receives a sound source from the AVN device 1 to allow the corresponding sound source to be reproduced in an independent form in a predetermined space in the vehicle, and may include the control unit 100, a communication unit 200, and a storage unit 300.

The control unit 100 receives a sound source from the AVN device 1 and generates a sound signal for focusing the output of the corresponding sound source in the bright zone BZ in the vehicle. The sound signal is the signal to be output from the speaker unit 5, and is generated by filter the sound source by using a predetermined filter coefficient.

The filter coefficient is the coefficient that makes a ratio of average spatial sound energy of the bright zone BZ (for example, driver's seat) and average spatial sound energy of a dark zone DZ (for example, seats other than the driver's seat) that is an area other than the bright zone BZ be the largest.

The sound signal generated by the control unit 100 is separated into multiple channels by the amp unit 4 and amplified, and output through the speaker unit 5. The sound output from the speaker unit 5 by the sound signal may be focused only in the set bright zone BZ.

In the foregoing description, it is assumed that the bright zone BZ is the area in which the driver's seat is located, but the location of the bright zone BZ may be differently set by a user input and the like. In particular, the user may set the location of the bright zone BZ or change the setting through the means, such as the touch screen (not illustrated), the jog shuttle (not illustrated), the switch (not illustrated), and the button (not illustrated), and in this case, the filter coefficient corresponding to the location of the bright zone BZ may be pre-stored in the storage unit 300 and referred when the control unit 100 generates the sound signal.

For example, referring to FIGS. 2A and 2B, the driver's seat (front left) may be set as the bright zone BZ and other seats (front right, rear left, and rear right) may be set as the dark zones DZ. That is, when the image is displayed on the touch screen as illustrated in FIG. 2B, and the user touches the location of the driver's seat (front left) and sets the location of the driver's seat (front left) as the bright zone BZ, the control unit 100 filters the sound source with the filter coefficient for setting the driver's seat (front left) as the bright zone BZ and generates a sound signal.

Further, when the user touches the location of the passenger's seat (front right) and sets the location of the passenger's seat as the bright zone BZ, the control unit 100 filters the sound source with the filter coefficient for setting the passenger's seat (front right) as the bright zone BZ and generates a sound signal. The filter coefficient for setting the driver's seat (front left) as the bright zone BZ and the filter coefficient for setting the passenger seat (front right) as the bright zone BZ may be pre-calculated. The bright zone BZ may be one or more seat areas.

That is, the filter coefficient for setting each of the seats (front left, front right, rear left, rear right) within the vehicle as the bright zone BZ may be already stored in the storage unit 300, and the control unit 100 may read the filter coefficient pre-stored in the storage unit 300 based on the user input, filter the sound source, generates a sound signal, and transmits the generated sound signal, so that the sound signal is output through the amp unit 4 and the speaker unit 5. As a matter of course, the sound output by the sound signal may be focused in the bright zone BZ set by the user.

In particular, in the present invention, the control unit 100 may receive vehicle driving state information from the communication unit 200, and update the filter coefficient read from the storage unit 300 according to the corresponding vehicle driving state information in real time. That is, the control unit 100 finally filters the sound source based on the updated filter coefficient, so that it is possible to control a volume adjustment range of the sound source so that the sound is reproduced in the bright zone.

The vehicle driving state information according to the exemplary embodiment of the present invention may include background noise inside the vehicle, such as engine noise and gear change noise, generated during the driving, not a sound by the sound source reproduced through the speaker unit 5.

When the control unit 100 determines that the background noise inside the vehicle is large due to the fast movement of the vehicle based on the vehicle driving state information, the volume adjustment range of the sound source so that the sound is reproduced in the bright zone may be relatively high. For example, in the case where it is determined that the background noise inside the vehicle is about 50 DB in the state where the difference between the bright zone and the dark zone is about 20 DB in the foregoing example, when the volume adjustment range of the sound source so that the sound is reproduced in the bright zone is adjusted to increase to 60 DB, the volume adjustment range of the sound source so that the sound is reproduced in the dark zone may be adjusted to about 40 DB. In this case, even though the volume adjustment range of the sound source is adjusted to about 40 DB in the dark zone, the sound is buried in the background noise of 50 DB, so that it is possible to achieve the effect as if no sound is reproduced in the dark zone in accordance with the original purpose of the personalized sound field formation.

In the meantime, when the control unit 100 determines that the background noise inside the vehicle is little due to the slow movement or the stop of the vehicle based on the vehicle driving state information, the volume adjustment range of the sound source so that the sound is reproduced in the bright zone may be relatively low. That is, the volume adjustment range of the sound source may be limited. For example, in the case where it is determined that the background noise inside the vehicle is about 10 DB in the state where the difference between the bright zone and the dark zone is about 20 DB in the foregoing example, when the volume adjustment range of the sound source so that the sound is reproduced in the bright zone is adjusted to decrease to 30 DB, the volume adjustment range of the sound source so that the sound is reproduced in the dark zone may be adjusted to decrease to about 10 DB. In this case, when the volume adjustment range of the sound source so that the sound is reproduced in the bright zone is set to about 60 DB and the volume adjustment range of the sound source so that the sound is reproduced in the dark zone is set to about 40 DB even in the state where the background noise inside the vehicle is 10 DB, even though the area is set as the dark zone, the sound is heard in the corresponding area as a result, so that it does not meet the original purpose of the personalized sound field formation. Accordingly, in the state where the background noise inside the vehicle is 10 DB, the volume adjustment range of the sound source so that the sound is reproduced in the dark zone is adjusted to 10 DB, so that the effect as if no sound is reproduced in the dark zone in accordance with the original purpose of the personalized sound field formation may be achieved.

Accordingly, it is possible to respect the listening style of each listener located on each seat according to the vehicle driving state, thereby controlling the personalized sound field.

Further, the adjustment of the volume adjustment range of the sound source so that the sound is reproduced in the focusing area according to the vehicle driving state information may be identically/similarly applied to the case where the number of reproduced sound sources is two or more. That is, in the case where the first sound source received from the mobile terminal is converted into the first sound signal by using the first filter coefficient through the first focusing area and the second sound source received from the AVN device 1 is converted into the second sound signal by using the second filter coefficient through the second focusing area, the volume adjustment range of the first sound source is adjusted by updating the first filtering coefficient according to the vehicle driving state information in the first focusing area, and simultaneously, the volume adjustment range of the second sound source is adjusted by updating the second filtering coefficient according to the vehicle driving state information in the second focusing area.

Information on an upper limit and a lower limit of the volume adjustment range of the source so that the sound is reproduced in the bright zone may be preset and stored in the storage unit 300. Further, the corresponding information may be pre-set in relation to the vehicle driving state information, and may also be changed by the user.

However, in the case of the present invention, the vehicle driving state information may include noise generated inside the vehicle, but may also include even the noise generated outside the vehicle according to another exemplary embodiment. In this case, it is possible to collect noise generated outside the vehicle by installing a separate microphone (not illustrated), reflect even the corresponding noise information, and update the filtering coefficient.

The control unit 100 may control so that the sound source signal supplied from the AVN device 1 is finally converted into the sound signal and output. The control unit 100 may adjust the volume of the sound source in the process of amplifying the sound signal by controlling the amp unit 4, and the sound signal is finally output through the speaker unit 5.

The storage unit 300 may store the filtering coefficient for setting each of the seats (front left, front right, rear left, rear right) as the bright zone BZ in various methods (for example, a table).

The communication unit 200 may receive the vehicle driving state information from the component (a sensor and the like, not illustrated) in the vehicle and transmit the received vehicle driving state information to the control unit 100. In the present invention, the vehicle driving state information may be received through a Controller Area Network (CAN), Ethernet, Flexray, a BroadR-Reach network, and the like.

The sensor (not illustrated) provided in the vehicle may include a pressure sensor, an acceleration sensor, a vehicle acceleration sensor, a vehicle deceleration sensor, a flow rate sensor, a temperature sensor, an intake air pressure sensor, a steering sensor, a collision avoidance sensor, an airbag sensor, a Throttle Position Sensor (TPS), an Air Temp sensor (ATS), an Accelerator Pedal Sensor (APS), a vehicle speed sensor, a G sensor, a gyro sensor, a collision detection sensor, an automobile height sensor, a suspension control sensor, an air-conditioner sensor, a radar sensor, a lidar sensor, an inertial measurement sensor, a satellite navigation sensor, a camera sensor, a pedal sensor, an oxygen saturation sensor, an infrared sensor, and the like. Herein, the vehicle sensor is not limited to the foregoing list, and it should be understood that the vehicle sensor means all of the sensors providable or mountable to the vehicle.

In the meantime, when a vibration measurement sensor, such as a strain gauge or an accelerometer, is provided, background noise information inside the vehicle may also be inversely calculated based on vibration information of the vehicle generated from the corresponding vibration measurement sensor.

The amp unit 4 separates the sound signal received from the control unit 100 into multiple channels and amplifies the sound signal, and the signal is transmitted to the speaker unit 5 and is output in the method in which the signal is focused in the bright zone BZ.

FIGS. 2A and 2B are diagrams illustrating an example in which the in-car personalized sound field forming device 3 is installed inside the vehicle.

In particular, as illustrated in FIGS. 2A and 2B, a focusing area setting system may be configured by a plurality of speakers spaced at an interval of 4 cm. Further, the focusing area may be formed in four seat areas, that is, the driver's area (front left, FL), the passenger seat area (front right, FR), the left rear seat area (rear left, RL), and the right rear seat area (rear right, RR), inside the vehicle illustrated in FIG. 2A. However, this is only the exemplary embodiment, and the setting system may be configured in various methods according to a size of the vehicle, an internal space structure, a location of an internal configuration, and the like.

Referring back to FIGS. 2A and 2B, a first speaker and a second speaker functioning as sounds are installed at a predetermined location in the sound source space (herein, corresponding to the internal space of the vehicle). The first speaker and the second speaker are not included in the areas of the bright zone (hereinafter, the “BZ”) and the dark zone (hereinafter, the “DZ”), but are not limited thereto.

The bright zone BZ means the area in which the sounds output from the first speaker and the second speaker are heard in a threshold value or more, and the dark zone DZ means the area in which the sounds output from the first speaker and the second speaker are heard in less than the threshold value. In brief, the bright zone BZ is the area in which the sound is heard, and means the area in which the user focuses a sound source, and the dark zone DZ is the area in which the sound is not heard, and may mean the area in which the user does not focus a sound source. The division of the bright zone BZ and the dark zone DZ is based on the contrast of the sound pressure level, more specifically, the contrast of the average spatial sound energy, so that the dark zone DZ area may be controlled so that no sound is heard, but may also be controlled so that a weak sound is detected.

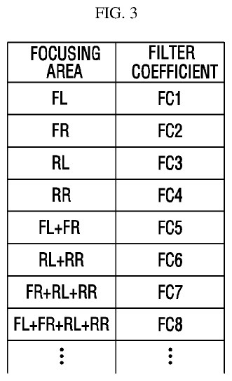

FIG. 3 is a diagram illustrating a lookup table stored in the storage unit 300 of the in-car personalized sound field forming device 3 according to the exemplary embodiment of the present invention.

The storage unit 300 may store the filter coefficient in the form of a lookup table as illustrated in FIG. 3. In this case, the internal space of the vehicle may be divided into the plurality of areas in which the output of the sound source may be focused, and in the lookup table, the filter coefficients corresponding to the plurality of divided areas, for example, the driver's seat area FL, the passenger seat area FR, the rear left seat area RF, and the rear right seat area RR, may be defined.

As illustrated in FIG. 3, in the lookup table stored in the storage unit 300, the focusing area and the filter coefficient corresponding to the focusing area are defined. When a first sound source signal is focused in the driver's seat area FL, that is, the driver's seat area FL is set as the bright zone BZ for the first sound source signal, the control unit 100 may filter the first sound source signal based on Filtering Coefficient 1 (FC1) and generate the corresponding first sound signal. In this case, the first sound signal is heard only in the driver's seat area FL, and may not be heard well or may not be heard at all in the rest of the area.

When a second sound source signal is focused in the driver's seat area FL and the passenger's seat area FR, that is, the driver's seat area FL and the passenger's seat area FR are set as the bright zone BZ for the second sound source signal, the control unit 100 may filter the second sound source signal based on Filter Coefficient 5 (FC5) and generate the corresponding second sound signal. In this case, the second sound signal is heard only in the driver's seat area FL and the passenger's seat area FR, and may not be heard well or may not be heard at all in the rest of the area. However, the storage method of the storage unit 300 is not limited to the lookup table of FIG. 3, and store the filter coefficient by using various methods.

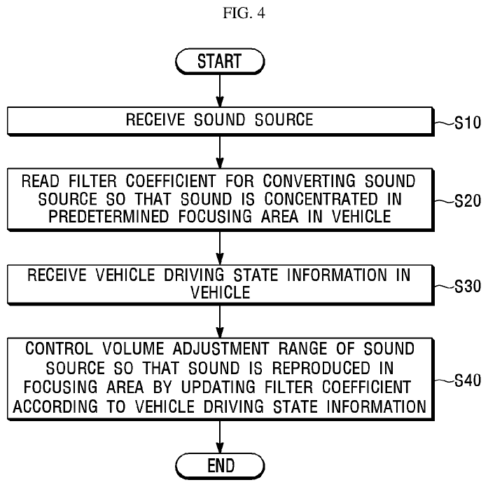

FIG. 4 is a flowchart for describing an in-car personalized sound field forming method of the in-car personalized sound field forming device 3 according to an exemplary embodiment of the present invention.

As illustrated in FIG. 4, the control unit 100 may receive a sound source through the AVN device 1 (s10). In this case, the sound source is received through the user input unit 2 and the corresponding sound source may also be reproduced. A filter coefficient for converting the sound source so that the sound is focused in a predetermined focusing area inside the vehicle is pre-stored in the storage unit 300, so that the control unit 100 may read the corresponding filter coefficient from the storage unit 300 (s20). In this case, the control unit 100 may convert the sound source into the sound based on the filter coefficient, so that the sound may be intensively reproduced in the focusing area. Further, the focusing area among the seats inside the vehicle may be selected by receiving a user command from the user input unit 2. In this situation, the control unit 100 may receive vehicle driving state information in the vehicle through the communication unit (or a vehicle driving information reception unit) 200 (s30). In particular, the vehicle driving state information may include background noise inside the vehicle. The control unit 100 may control a volume adjustment range of the sound source so that the sound is reproduced in the focusing area by updating the filter coefficient in real time according to the vehicle driving state information (s40). The converted sound in the situation where the volume adjustment range of the sound source is controlled may be amplified through the amp 4 and reproduced through the speaker unit 5.

The volume adjustment range of the sound source is adjusted to increase or limited to decrease, so that the sound source is not heard in a non-focusing area, so that the effect of the personalized sound field may be realistically exhibited. The aforementioned characteristic, structure, effect, and the like described in the exemplary embodiments are included in one exemplary embodiment of the present invention, and are not essentially limited to only one exemplary embodiment. Further, the characteristic, structure, effect, and the like described in each exemplary embodiment may be carried out in other exemplary embodiments through combination or modification by those skilled in the art to which the exemplary embodiments pertain. Accordingly, it shall be construed that contents relating to the combination and the modification are included in the scope of the present invention.

In addition, although the exemplary embodiments have been described above, these are only examples, and do not limit the present invention, and those skilled in the art will know that various modifications and applications which are not exemplified above are possible within the scope without departing from the essential characteristics of the present exemplary embodiment. For example, each component specifically presented in the exemplary embodiment may be modified and implemented. Further, it should be interpreted that the differences in relation to the modification and the application are included in the scope of the present invention defined in the accompanying claims.

### INDUSTRIAL APPLICABILITY

In the present invention, the effect of the personalized sound field implemented so that a sound is not heard well in the non-focusing area may be more accurately reflected by controlling a range of sound reproducible in a focusing area set so that a sound is relatively heard well in consideration of even vehicle driving state information.

In particular, an independent listening style of an individual user positioned on each seat may be further guaranteed.

It is possible to focus a sound in a vehicle in a specific area by using an existing speaker mounted in the vehicle or mounting only an additional speaker for improvement of performance.

It is possible to respect the listening style of each listener located on each seat according to a vehicle driving state, thereby controlling the personalized sound field.

Additionally, the sound may be controlled to be heard only in a specific location (bright zone) and controlled to be very weakly heard or not to be heard in other locations (dark zone), and a user may select or adjust the sound focusing in the vehicle.

The object of the present invention is to provide a personalized sound field forming device which is capable of focusing a sound inside a vehicle in a specific area by using an existing mounted speaker without changing a location of the speaker in the vehicle.

According to the exemplary embodiment of the present invention, it is only necessary to separately insert the in-car personalized sound field forming device into the existing system without replacing a in-car AVN device already installed in the vehicle, so that there is an advantage in that a personalized sound field forming system is more easily implemented.

1. An in-car personalized sound field forming device which communicates with a device for providing a sound source, the in-car personalized sound field forming device comprising:
a storage unit configured to store a filter coefficient for converting the sound source so that a sound is concentrated in a predetermined focusing area in a vehicle;
a communication unit configured to receive vehicle driving state information in the vehicle; and
a control unit configured to update the filter coefficient according to the vehicle driving state information received from the communication unit and control a volume adjustment range of the sound source so that the sound is reproduced in the focusing area.

2. The in-car personalized sound field forming device of claim 1, wherein the filter coefficient makes a ratio of an average spatial sound energy of the focusing area and an average spatial sound energy of an area other than the focusing area be the largest.

3. The in-car personalized sound field forming device of claim 1, wherein the communication unit receives the vehicle driving state information through CAN communication.

4. The in-car personalized sound field forming device of claim 1, wherein the vehicle driving state information includes background noise information in the vehicle, and
the background noise information in the vehicle is calculated based on noise and vibration information generated from a vibration measurement sensor that measures noise and vibration of the vehicle.

5. The in-car personalized sound field forming device of claim 1, wherein the predetermined focusing area in the vehicle is an area selected from among a plurality of areas through a user input.

6. The in-car personalized sound field forming device of claim 5, wherein the sound source includes a first sound source received from a mobile terminal performing the user input and a second sound source stored in an AVN device,
the first sound source is converted into a first sound signal through a first focusing area,
the second sound source is converted to a second sound signal through a second focusing area, and
a selection for the first focusing area and a selection for the second focusing area are based on the user input through the mobile terminal.

7. A method of forming a personalized sound field in a in-car personalized sound field forming device, the method comprising:
receiving a sound source;
reading a filter coefficient for converting the sound source so that a sound is concentrated in a predetermined focusing area in a vehicle;
receiving vehicle driving state information in the vehicle; and
updating the filter coefficient according to the vehicle driving state information and controlling a volume adjustment range of the sound source so that the sound is reproduced in the focusing area.

8. The method of claim 7, wherein the filter coefficient makes a ratio of an average spatial sound energy of the focusing area and an average spatial sound energy of an area other than the focusing area be the largest.

9. The method of claim 7, wherein the vehicle driving state information is received through CAN communication.

10. The method of claim 7, wherein the vehicle driving state information includes background noise information in the vehicle, and
the background noise information in the vehicle is calculated based on vibration information generated from a vibration measurement sensor that measures noise and vibration of the vehicle.

11. The method of claim 7, wherein the predetermined focusing area in the vehicle is an area selected from among a plurality of areas through a user input.

12. The method of claim 11, wherein the sound source includes a first sound source received from a mobile terminal performing the user input and a second sound source stored in an AVN device,
the first sound source is converted into a first sound signal in a first focusing area by using a first filter coefficient,
the second sound source is converted into a second sound signal in a second focusing area by using a second filter coefficient, and
a selection for the first focusing area and a selection for the second focusing area are based on the user input through the mobile terminal.
